(19) United States
(12) Patent Application Publication
(10) Pub. No.: US 2023/0200403 A1
(43) Pub. Date: Jun. 29, 2023

(54) METHOD FOR TREATING RAW MATERIALS OF PLANT-DERIVED FOOD

(71) Applicant: China Agricultural University, Beijing (CN)

(72) Inventors: Li Dong, Beijing (CN); Kangyi Mou, Beijing (CN); Jianran Qin, Beijing (CN); Xiaosong Hu, Beijing (CN); Fang Chen, Beijing (CN)

(21) Appl. No.: 17/965,760

(22) Filed: Oct. 13, 2022

(30) Foreign Application Priority Data
Dec. 27, 2021 (CN) 202111614556.6

(51) Int. Cl. A23B 7/015

(52) U.S. Cl. CPC A23B 7/015; A23V 2002/00

(57) ABSTRACT

The invention discloses a method for treating raw materials of plant-derived food, wherein the method comprises the following steps: mixing raw materials of plant-derived food with a solution containing photosensitizer to obtain a mixing liquid; carrying out light treatment of the mixing liquid; collecting raw materials in the mixing liquid subjected to light treatment, and performing drying treatment of the raw materials. The method can effectively realize sterilization effect, especially effectively reduce spore contamination, so as to ensure the safety of food and extend the shelf life; besides, the method can keep the original color, flavor, taste and nutrition contents of plant-derived food, and improve the edible value of plant-derived food.

### BACKGROUND OF THE INVENTION

### 1. Field of the Invention

The invention relates to the field of food, in particular to a method for treating raw materials of plant-derived food.

### 2. Description of Related Art

Sterilization, a very important link in the process of food production and processing, can not only ensure the safety of food, but also appropriately extend the shelf life of food. For raw materials of plant-derived food, they contain a variety of microorganisms from dust, soil, etc., and their original floras, especially bacterial spores, are complex; if a large number of bacteria spores exist in food or cannot be completely inactivated, the commercial sterilization of food cannot be guaranteed. Therefore, inactivation of bacterial spores is a key point of food sterilization.

The bacterial spores are highly resistant to high pressure and high temperature. Under realistic conditions, for inactivation of the bacterial spores with high resistance, if the food where they exist is not subjected to high-intensity thermal treatment, they cannot be guaranteed to be killed within the safety scope of food, while if the food where they exist is subjected to high-intensity thermal treatment, the high-intensity thermal treatment causes adverse affect on the food quality. With the continuous improvement of living standards, people pay more attention to high-nutrition, pure-nature and simple-treatment food, so non-thermal sterilization technology is particularly important in food sterilization in order to meet consumers' demand for high-quality food; non-thermal sterilization technology can not only ensure the safety of food in the aspect of microorganisms, but also better retain the nutritional value and sensory attributes of food.

At present, non-thermal sterilization technologies mainly include microwave sterilization technology, radio frequency sterilization technology, ultra-high pressure sterilization technology and irradiation sterilization technology. The microwave sterilization technology and the radio frequency sterilization technology belong to thermal sterilization technologies and tend to cause damage to the color, flavor and taste of food; the microwave sterilization and the radio frequency sterilization have higher requirements for the moisture content of raw materials, so it is easy to produce corner effect when the moisture content is low, resulting in coking of raw materials due to local overheating; when superheated steam is used for sterilization, the flow of steam may lead to the loss of volatile components in low-moisture raw materials, and operation process is more complicated because of drying process addition caused by moist heat conditions increasing the moisture content of dried materials. The ultra-high pressure sterilization technology and the irradiation sterilization technology belong to non-thermal sterilization technologies, although they do not affect the color, flavor and taste of food, the ultra-high pressure technology has some disadvantages, such as high cost, huge equipment and low single treatment capacity, and is only suitable for high value-added products, and the irradiation sterilization technology affects the safety of food due to easy generation of irradiation off-odor and high irradiation dose.

Therefore, at present, the method for treating raw materials of plant-derived food is still need to be studied.

### SUMMARY OF THE INVENTION

The invention aims at solving at least one of the technical problems existing in the prior art to a certain extent. Given this, the invention provides a method for treating raw materials of plant-derived food to effectively realize the sterilization effect, especially effectively kill spores, so as to ensure the safety of food and extend the shelf life; besides, the method can keep the original color, flavor, taste and nutrition contents of plant-derived food, and improve the edible value of plant-derived food.

The invention provides a method for treating raw materials of plant-derived food. According to the embodiment of the invention, the method comprises the following steps: mixing raw materials of plant-derived food with a solution containing photosensitizer to obtain a mixing liquid; carrying out light treatment of the mixing liquid; collecting raw materials in the mixing liquid subjected to light treatment, and performing drying treatment of the raw materials.

According to the method of the embodiment of the invention, when the mixing liquid obtained by mixing a photosensitizer with the raw materials of plant-derived food is subjected to light treatment, the photosensitizer generates highly damaging active oxygen after being excited by light with a specific wavelength, and the active oxygen quickly reacts with surrounding microorganisms to cause damage to them, thus achieving the purpose of killing the microorganisms.

Furthermore, the inventor found that the sequence of performing light sterilization significantly affects the sterilization effect. If light sterilization is performed after drying treatment, the sterilization effect is not good because the moisture content of the raw materials is low, and the microorganisms in the raw materials, such as Bacillus, mainly exist in the form of spores with multilayer membrane structures so that they are difficult to be killed; if light sterilization is performed before drying treatment, the sterilization effect is good because the microorganisms can be effectively killed.

It should be noted that the solution contains water, wherein the water may be from the raw materials of plant-derived food or from the photosensitizer solution, or may be added additionally, with the specific source flexibly selected according to the actual situation.

According to the embodiment of the invention, the method for treating raw materials of plant-derived food may also have the following additional technical features:

According to the embodiment of the invention, pepper, onion and garlic are used as the raw materials of plant-derived food.

According to the embodiment of the invention, the raw materials of plant-derived food are crushed to particles with sizes of 0.5˜5.0 cm before the mixing treatment, so that the photosensitizer can fully contact with the raw materials, so as to achieve a better sterilization effect.

According to the embodiment of the invention, sodium copper chlorophyllin, curcumin or riboflavin is used as the photosensitizer.

According to the embodiment of the invention, when sodium copper chlorophyllin is used as the photosensitizer, the mass ratio of the raw materials of plant-derived food to the photosensitizer in the mixing liquid is (1˜30): 1 based on the total volume of the mixing liquid, preferably (10˜20): 1, so that the photosensitizer can fully contact with the raw materials, so as to achieve a better sterilization effect.

According to the embodiment of the invention, when curcumin is used as the photosensitizer, the mass ratio of the raw materials of plant-derived food to the photosensitizer in the mixing liquid is (10,000˜20,000): 1 based on the total volume of the mixing liquid, preferably (14,000˜16,000): 1.

According to the embodiment of the invention, the wavelength, irradiation time and power adopted for the light treatment are 420˜600 nm, 10˜80 min and 100˜200 W respectively, so as to achieve a better sterilization effect.

According to the embodiment of the invention, when sodium copper chlorophyllin is used as the photosensitizer, the wavelength and irradiation time adopted for the light treatment are 420˜530 nm and 50˜70 min respectively, so as to achieve a better sterilization effect.

According to the embodiment of the invention, when curcumin is used as the photosensitizer, the wavelength and irradiation time adopted for the light treatment are 460˜520 nm and 10˜20 min respectively, so as to achieve a better sterilization effect.

According to the embodiment of the invention, the solution containing a photosensitizer can be directly used as the raw material cleaning fluid, that is, the photosensitizer is added in the process of raw material cleaning, and light treatment is carried out, so as to achieve a sterilization effect; or the raw materials of plant-derived food are cleaned before the mixing treatment, and they are mixed with the photosensitizer for light treatment after dust, dirt and other attachments on the raw materials of plant-derived food are removed, so as to achieve a better sterilization effect.

Additional aspects and advantages of the invention will be set forth in part in the following description, and part of them will be obvious from the following description, or may be known by practice of the invention.

### DETAILED DESCRIPTION OF THE PREFERRED EMBODIMENTS

The scheme of the invention will be explained in the embodiment below. Those skilled in the art will understand that the following embodiment is only used to illustrate the invention, and should not be regarded as limiting the scope of the invention. If the specific technology or conditions are not indicated in the embodiment, the technology or conditions described in the literature in this field or the product specification shall be followed. The adopted reagents or instruments, with manufacturer not indicated, are conventional products can be obtained through purchase in the market.

### Embodiment 1

1. Sample Treatment:

(1) Experiment 1: clean 100 g of unsterilized onion, garlic and white pepper, respectively, crush them to particles with sizes of 0.5˜5.0 cm, dissolve into 1 L of 0.9% normal saline, and shake fully and evenly to obtain a liquid with the three kinds of raw materials for later use.

Experiment 2: dry and pulverize the onion, garlic and white pepper crushed in Experiment 1 to obtain onion powder, garlic powder and white pepper powder, dissolve the three kinds of powders into 0.9% normal saline, and shake fully and evenly to obtain a liquid with the three kinds of powders for later use.

Preparation of photo sensitizer: prepare 8 mmol/L sodium copper chlorophyllin solution and 35 μmol/L curcumin solution respectively from light.

(2) Experiment 1 and Experiment 2 are carried out by the following four groups respectively:

Light experiment (PDT) group: different types of photosensitizers were added in each group of experiments; light was applied after incubation from light.

Single photosensitizer control group: the grouping method was the same as PDT group; no light was applied after incubation from light.

Single light control group: no photosensitizer was added; light was applied together with PDT group after incubation from light.

Blank control group: no photosensitizer was added; no light was applied after incubation from light.

Samples were loaded according to the sample loading method in Table 1, with the incubation time of 45 min, and then they were placed in a 150 W light source (the wavelength of sodium copper chlorophyllin experimental group was 520 nm, and that of curcumin experimental group was 520 nm), wherein the sodium copper chlorophyllin experimental group was lighted for 63.84 min, while the curcumin experimental group was lighted for 15 min. The concentration of photosensitizer added in the single photosensitizer control group was the same as that of photosensitizer added in the light experiment group, but the single photosensitizer control group was not subjected to light treatment; for the single light control group, no photosensitizer was added, but the light conditions were the same as those of the light experimental group; the blank control group was not subjected to any treatment.

TABLE 1
Ratio of photosensitizer to raw material/powder liquid

| | Light | Single | Single light | Blank |
|---|---|---|---|---|
| Reagent | experiment | photosensitizer | control | control |
| (mL) | group | control group | group | group |
| Raw material/ | 2 | 2 | 2 | 2 |
| powder liquid | | | | |
| Photosensitizer | 2 | 2 | 0 | 0 |
| Sterile water | 0 | 0 | 2 | 2 |

(3) After treatment, suck up 25 mL of liquid from each group and dilute with 225 mL of sterile normal saline to obtain 10⁻¹ diluted solution, and so on to obtain 10⁻²˜10⁻⁷ diluted solution, fully mix them on a vortex shaker, select an appropriate dilution gradient, suck up 100 μL of bacterial solution and inoculate on a LB plate, coat evenly, and place in an incubator at 37° C. for 24 h; calculate the survival bacteria count after treatment in each group, and then calculate the survival rate of bacteria; set up three parallel controls in each group of experiments, with each experiment repeated for three times.

$$Survival rate of bacteria ( \% ) = \frac{Total bacterial count in experimental group ( log CFU / mL )}{Total bacterial count in blank control group ( log CFU / mL )} \times 100$$

2. Results and Analysis

In Experiment 1, after the original floras of white pepper, garlic and onion were sterilized by light, the bacteria count changed significantly, with the specific data shown in Table 2 and Table 3 (the survival bacteria count log CFU/mL is shown in the tables), showing that sterilization effect is better if sterilization treatment is performed before drying treatment.

TABLE 2
Sterilization for three kinds of powders by PDT treatment with
sodium copper chlorophyllin taken as photosensitizer

| Sample name | White pepper | Garlic | Onion |
|---|---|---|---|
| (logCFU/mL) | powder | powder | powder |
| Light experiment | 1.41 ± 0.089^{b} | 1.03 ± 0.550^{b} | 1.12 ± 0.170^{b} |
| group | | | |
| Single light | 5.19 ± 0.008^{ab} | 4.87 ± 0.103^{a} | 5.13 ± 0.012^{a} |
| control group | | | |
| Single sodium copper | 5.24 ± 0.120^{a} | 4.75 ± 0.037^{a} | 5.09 ± 0.064^{a} |
| chlorophyllin group | | | |
| Blank control group | 5.39 ± 0.014^{a} | 4.90 ± 0.008^{a} | 5.18 ± 0.049^{a} |

TABLE 3
Sterilization for three kinds of powders by PDT treatment
with curcumin taken as photosensitizer

| Sample name | White pepper | Garlic | Onion |
|---|---|---|---|
| (logCFU/mL) | powder | powder | powder |
| Light experiment | 1.12 ± 0.033^{c} | 0.95 ± 0.000^{c} | 1.05 ± 0.025^{b} |
| group | | | |
| Single light control | 5.89 ± 0.008^{b} | 4.89 ± 0.103^{b} | 5.37 ± 0.028^{a} |
| group | | | |
| Single curcumin | 5.97 ± 0.029^{b} | 4.97 ± 0.073^{b} | 5.32 ± 0.028^{a} |
| control group | | | |
| Blank control group | 6.02 ± 0.014^{a} | 5.09 ± 0.008^{a} | 5.46 ± 0.049^{a} |

In Experiment 2, after the original floras of white pepper, garlic and onion were sterilized by light, the bacteria count in the garlic powder did not change significantly, while the bacteria count in the onion powder and the white pepper decreased, but the sterilization efficiency was low (less than 10%), with the specific data shown in Table 4 and Table 5 (the survival rate of bacterial % is shown in the tables), showing that sterilization effect is worse if sterilization treatment is performed after drying treatment.

TABLE 4
Sterilization for three kinds of powders by PDT treatment with
sodium copper chlorophyllin taken as photosensitizer

| Sample name | White pepper | Garlic | Onion |
|---|---|---|---|
| (logCFU/mL) | powder | powder | powder |
| Light experiment group | 91.81 ± 2.65^{b} | 73.20 ± 28.99^{a} | 89.92 ± 0.56^{b} |
| Single light control group | 94.26 ± 0.23^{ab} | 93.39 ± 5.44^{a} | 95.49 ± 0.93^{a} |
| Single sodium copper | 98.67 ± 3.55^{a} | 92.52 ± 1.98^{a} | 96.18 ± 2.09^{a} |
| chlorophyllin group | | | |

TABLE 5
Sterilization for three kinds of powders by PDT
treatment with curcumin taken as photosensitizer

| Sample name | White pepper | Garlic | Onion |
|---|---|---|---|
| (logCFU/mL) | powder | powder | powder |
| Light experiment | 95.43 ± 0.96^{c} | 97.23 ± 0.00^{a} | 96.56 ± 0.81^{b} |
| group | | | |
| Single light | 94.26 ± 0.23^{c} | 93.39 ± 5.44^{a} | 95.49 ± 0.93^{b} |
| control group | | | |
| Single curcumin | 97.67 ± 0.88^{b} | 92.25 ± 3.84^{a} | 96.35 ± 0.93^{b} |
| control group | | | |

In the description of this specification, the terms “one embodiment”, “some embodiments”, “example”, “specific example” or “some examples” mean that the specific features, structures, materials or characteristics described in combination with the embodiment or the example are included in at least one embodiment or example of the invention. In this specification, the illustrative expressions of the above terms are not necessarily for the same embodiment or example. Furthermore, the described specific features, structures, materials or characteristics may be combined in any one or more embodiment (s) or example (s) in a suitable manner. In addition, those skilled in the art can combine the different embodiments or examples and the features of the different embodiments or examples described in this specification without contradicting each other.

Although the embodiment of the invention has been shown and described above, the above embodiment is illustrative and should not be construed as limitation of the invention, and those skilled in the art can make changes, modifications, substitutions and variations to the above embodiment within the scope of the invention.

What is claimed is:

1. A method for treating raw materials of plant-derived food comprises:
Mixing raw materials of plant-derived food with a solution containing photosensitizer to obtain a mixing liquid;
Carrying out light treatment of the mixing liquid;
Collecting raw materials in the mixing liquid subjected to light treatment, and performing drying treatment of the raw materials.

2. The method according to claim 1 is characterized in that pepper, onion and garlic are used as the raw materials of plant-derived food.

3. The method according to claim 1 is characterized in that the raw materials of plant-derived food are crushed to particles with sizes of 0.5˜5.0 cm before the mixing treatment.

4. The method according to claim 1 is characterized in that sodium copper chlorophyllin, riboflavin or curcumin is used as the photosensitizer.

5. The method according to claim 1 is characterized in that when sodium copper chlorophyllin is used as the photosensitizer, the mass ratio of the raw materials of plant-derived food to the photosensitizer in the mixing liquid is (1˜30): 1 based on the total volume of the mixing liquid, preferably (10˜20): 1;
When curcumin is used as the photosensitizer, the mass ratio of the raw materials of plant-derived food to the photosensitizer in the mixing liquid is (10,000˜20,000): 1 based on the total volume of the mixing liquid, preferably (14,000˜16,000): 1.

6. The method according to claim 1 is characterized in that the wavelength, irradiation time and power adopted for the light treatment are 420˜600 nm, 10˜80 min and 100˜200 W respectively;
When sodium copper chlorophyllin is used as the photosensitizer, the wavelength and irradiation time adopted for the light treatment are 420˜530 nm and 50˜70 min respectively;
When curcumin is used as the photosensitizer, the wavelength and irradiation time adopted for the light treatment are 460˜520 nm and 10˜20 min respectively.

7. The method according to claim 1 is characterized in that the raw materials of plant-derived food are cleaned before the mixing treatment.
